(19) United States
(12) Patent Application Publication
(10) Pub. No.: US 2020/0334110 A1
(43) Pub. Date: Oct. 22, 2020

(54) Method for Restoring a Blockchain Network Via Synchronizations While Maintaining Reliability on Backup Data and Minimizing Resource Usage by Converting the Identities of Nodes Adaptively, and the Nodes Using the Same

(71) Applicant: WAY2BIT CO. LTD., Gyeonggi-do (KR)

(72) Inventors: Gye Han Song, Gyeonggi-do (KR); I Goo Lee, Seoul (KR); Dong Jin Seo, Seoul (KR)

(21) Appl. No.: 16/850,276

(22) Filed: Apr. 16, 2020

(30) Foreign Application Priority Data
Apr. 18, 2019 (KR) 10-2019-0045768

(51) Int. Cl. G06F 11/14; H04L 9/06; G06F 11/20

(52) U.S. Cl. CPC G06F 11/1464; H04L 2209/38; G06F 11/2076; H04L 9/0637

(57) ABSTRACT

A method for restoring a blockchain network via synchronizations while maintaining a reliability on backup data and minimizing resource usage by converting identities of nodes adaptively is provided. The method includes steps of: (a) a specific delayed node among one or more delayed nodes in the blockchain network performing synchronization with the existing service nodes while the specific delayed node maintains a specific delay according to a specific initial setting thereof; (b) the specific delayed node, in response to acquiring the triggering command, allowing at least some of the existing service nodes to perform synchronization based on blocks included in the specific delayed node without the specific delay, to thereby convert the identity thereof into a new service node.

### CROSS-REFERENCE TO RELATED APPLICATION

This application claims priority to Korean Application Patent Serial No. 10-2019-0045768, filed Apr. 18, 2019, the entire disclosure of which is hereby incorporated by reference.

### TECHNICAL FIELD

The present a method for restoring a blockchain network via synchronizations while maintaining a reliability on backup data and minimizing resource usage by converting identities of nodes adaptively, and the nodes using the same.

### BACKGROUND

Blockchain technology is a technology aimed to prevent data tampering based on distributed computing technology, by storing data in blocks, which are a chain-type distributed data store based on a P2P method.

In order to prevent the data tampering, the blockchain technology may prevent data written in the blocks from being revised. However, an aforementioned characteristic of the blockchain technology may also result in a difficulty in correcting an error occurred on the data. The only way to correct the error is overwriting blockchain network with backup data prepared before the error occurs and then restarting synchronization among service nodes in the blockchain network.

When it comes to preparing the backup data, there have been methods considered as conventional backup methods, such as a method of stopping synchronization at a specific point of time then performing a cold backup on an OS level, and another method of backing up information for specific block or a specific section comprised of one or more blocks. However, these methods have disadvantages in long restoring time and less reliable backed up data.

In this regard, a need is growing for a solution that can effectively restore the blockchain network up to the latest block, i.e., a block generated right before the error occurs, while a reliability of backup is maintained, but the research on this field has not been conducted enough yet.

### SUMMARY

It is an object of the present disclosure to solve the aforementioned problems.

It is another object of the present disclosure to provide a method for restoring a blockchain network via synchronizations while maintaining a reliability on backup data.

It is still another object of the present disclosure to provide a prompt and easy method for restoring the blockchain network via the synchronizations while maintaining the reliability on the backup data for an administrator.

It is still yet another object of the present disclosure to provide a method for restoring a blockchain network via synchronizations while maintaining a reliability on backup data and minimizing resource usage by converting identities of nodes adaptively.

In accordance with one aspect of the present disclosure, there is provided the method for restoring the blockchain network via the synchronizations while maintaining the reliability on the backup data and minimizing resource usage by converting the identities of the nodes adaptively, including steps of: (I) a specific delayed node among one or more delayed nodes in the blockchain network performing delayed synchronization, wherein the delayed synchronization represents synchronization with the existing service nodes while the specific delayed node maintains a specific delay according to a specific initial setting of the specific delayed node, and (II) the specific delayed node which is set to perform a conversion of an identity thereof when a triggering command is acquired from an administrating device in the blockchain network, in response to acquiring the triggering command, allowing at least some of the existing service nodes to perform restoration synchronization, to thereby convert the identity thereof into a new service node, wherein the restoration synchronization represents synchronization based on blocks included in the specific delayed node without the specific delay.

As one example, at the step of (II), the specific delayed node, by referring to a reference block number in the triggering command and a latest delayed block number of the specific delayed node, wherein the reference block number represents a latest service block number in each of the existing service nodes before an error occurs, performs (i) a process of stopping the delayed synchronization and allowing at least some of the existing service nodes to perform the restoration synchronization in a first case, wherein the first case represents a case in which the reference block number corresponds to the latest delayed block number, and (ii) a process of stopping the delayed synchronization, performing additional synchronization, and allowing at least some of the existing service nodes to perform the restoration synchronization in a second case, wherein the second case represents a case in which the reference block number is bigger than the latest delayed block number, and wherein the additional synchronization represents synchronization with the existing service nodes to thereby update the specific delayed node.

As one example, at the step of (II), in the second case, during the process of performing the additional synchronization, the specific delayed node is updated by acquiring additional blocks comprised of from a subsequent block of the latest delayed block thereof to the reference block.

As one example, at the step of (II), the specific delayed node performs (i) a process of stopping the delayed synchronization and allowing at least some of the existing service nodes to perform the restoration synchronization in a first case, wherein the first case represents a case in which the triggering command includes an instruction for converting the identity thereof without additional synchronization, and (ii) a process of stopping the delayed synchronization, performing the additional synchronization by referring to a reference block number in the triggering command, and allowing at least some of the existing service nodes to perform the restoration synchronization in a second case, wherein the second case represents a case in which the triggering command includes both the instruction for the converting the identity thereof and an instruction for the additional synchronization, wherein the reference block number represents a latest service block number in the existing service nodes before an error occurs, and wherein the additional synchronization represents synchronization with the existing service nodes by obtaining additional blocks comprised of from a subsequent block of a latest delayed block thereof to the reference block.

As one example, the blockchain network includes each of the delayed nodes set by the administrating device to have each of delays, and the administrating device transmits the triggering command to the specific delayed node, to thereby allow the identity of the specific delayed node to be converted into the new service node, while the rest of the delayed nodes, which are failed to acquire the triggering command, maintain their identity as the delayed nodes.

In accordance with another aspect of the present disclosure, there is provided the method for restoring the blockchain network via the synchronizations while maintaining the reliability on the backup data and minimizing resource usage by converting the identities of the nodes adaptively, including steps of: (a) a specific existing service node among one or more existing service nodes in the blockchain network, which is set to perform a corresponding function when one of a first to a third triggering commands is acquired from the administrating device, performing a process of initializing itself when the first triggering command is acquired, and (b) the specific existing service node performing a process of (i) if the second triggering command is acquired, performing restoration synchronization with a specific delayed node among one or more delayed nodes in the blockchain network, to thereby allow an identity of the specific delayed node to be converted into a new service node in response to a conversion triggering command, resulting in completeness of an updated service data chain comprised of the existing service nodes and the new service node, wherein the restoration synchronization represents synchronization based on blocks included in the specific delayed node without the specific delay, and (ii) if the third triggering command is acquired, by referring to information on a certain delay included in the third triggering command, performing delayed synchronization with the updated service data chain while maintaining the certain delay, to thereby convert an identity thereof into a new delayed node.

As one example, before the step of (a), the specific delayed node performs delayed synchronization with the existing service nodes, and at the step of (b), in case that the specific existing service node acquires the second triggering command, the specific delayed node allows the specific existing service node to perform the restoration synchronization, to thereby maintain the identity of the specific existing service node as it is.

In accordance with still another aspect of the present disclosure, there is provided the specific delayed node for restoring the blockchain network via the synchronizations while maintaining the reliability on the backup data and minimizing resource usage, including: at least one memory that stores instructions; and at least one processor configured to execute the instructions to perform or support another device to perform: (I) a process of performing delayed synchronization, wherein the delayed synchronization represents synchronization with the existing service nodes while the specific delayed node maintains a specific delay according to a specific initial setting of the specific delayed node, and (II) in response to acquiring the triggering command from the administrating device, a process of allowing at least some of the existing service nodes to perform restoration synchronization, to thereby convert the identity thereof into a new service node, wherein the restoration synchronization represents synchronization based on blocks included in the specific delayed node without the specific delay.

As one example, at the process of (II), the processor, by referring to a reference block number in the triggering command and a latest delayed block number of the specific delayed node, wherein the reference block number represents a latest service block number in each of the existing service nodes before an error occurs, performs (i) a process of stopping the delayed synchronization and allowing at least some of the existing service nodes to perform the restoration synchronization in a first case, wherein the first case represents a case in which the reference block number corresponds to the latest delayed block number, and (ii) a process of stopping the delayed synchronization, performing additional synchronization, and allowing at least some of the existing service nodes to perform the restoration synchronization in a second case, wherein the second case represents a case in which the reference block number is bigger than the latest delayed block number, and wherein the additional synchronization represents synchronization with the existing service nodes to thereby update the specific delayed node.

As one example, at the process of (II), in the second case, during the process of performing the additional synchronization, the specific delayed node is updated by acquiring additional blocks comprised of from a subsequent block of the latest delayed block thereof to the reference block.

As one example, at the process of (II), the processor performs (i) a process of stopping the delayed synchronization and allowing at least some of the existing service nodes to perform the restoration synchronization in a first case, wherein the first case represents a case in which the triggering command includes an instruction for converting the identity thereof without additional synchronization, and (ii) a process of stopping the delayed synchronization, performing the additional synchronization by referring to a reference block number in the triggering command, and allowing at least some of the existing service nodes to perform the restoration synchronization in a second case, wherein the second case represents a case in which the triggering command includes both the instruction for the converting the identity thereof and an instruction for the additional synchronization, wherein the reference block number represents a latest service block number in the existing service nodes before an error occurs, and wherein the additional synchronization represents synchronization with the existing service nodes by obtaining additional blocks comprised of from a subsequent block of a latest delayed block thereof to the reference block.

As one example, the blockchain network includes each of the delayed nodes set by the administrating device to have each of delays, and the administrating device transmits the triggering command to the specific delayed node, to thereby allow the identity of the specific delayed node to be converted into the new service node, while the rest of the delayed nodes, which are failed to acquire the triggering command, maintain their identity as the delayed nodes.

In accordance with still yet another aspect of the present disclosure, there is provided the specific existing service node for restoring the blockchain network via the synchronizations while maintaining the reliability on the backup data and minimizing resource usage, including: at least one memory that stores instructions; and at least one processor configured to execute the instructions to perform or support another device to perform: (I) a process of performing a process of initializing itself when a first triggering command is acquired, (II) a process of performing a process of (i) if a second triggering command is acquired, performing restoration synchronization with a specific delayed node among one or more delayed nodes in the blockchain network, to thereby allow an identity of the specific delayed node to be converted into a new service node in response to a conversion triggering command, resulting in completeness of an updated service data chain comprised of the existing service nodes and the new service node, wherein the restoration synchronization represents synchronization based on blocks included in the specific delayed node without the specific delay, and (ii) if a third triggering command is acquired, by referring to information on a certain delay included in the third triggering command, performing delayed synchronization with the updated service data chain while maintaining the certain delay, to thereby convert an identity thereof into a new delayed node.

As one example, before the process of (I), the specific delayed node performs delayed synchronization with the existing service nodes, and, at the process of (II), in case that the processor acquires the second triggering command, the specific delayed node allows the specific existing service node to perform the restoration synchronization, to thereby maintain the identity of the specific existing service node as it is.

### BRIEF DESCRIPTION OF THE DRAWINGS

The above and other objects and features of the present disclosure will become apparent from the following description of preferred embodiments given in conjunction with the accompanying drawings. The accompanying drawings used to explain example embodiments of the present disclosure are only part of example embodiments of the present disclosure and other drawings can be obtained based on the drawings by those skilled in the art of the present disclosure without inventive work.

FIG. 1 is a drawing representing a specific delayed node among one or more delayed nodes in a blockchain network, a specific existing service node among one or more existing service nodes in the blockchain network, and an administrating device in the blockchain network, which perform a method for restoring a blockchain network via synchronizations while maintaining a reliability on backup data and minimizing resource usage by converting identities of nodes adaptively, in accordance with one example embodiment of the present disclosure.

FIG. 2 is a drawing representing the relationships among the delayed nodes, the existing service nodes, and the administrating device, which perform the method for restoring the blockchain network via the synchronizations while maintaining the reliability on the backup data and minimizing resource usage by converting the identities of the nodes adaptively, in accordance with one example embodiment of the present disclosure.

FIG. 3 is a drawing representing an example process of the specific delayed node interacting with the existing service nodes in the first case, wherein the specific delayed node performs the method for restoring the blockchain network via the synchronizations while maintaining the reliability on the backup data and minimizing resource usage by converting the identities of the nodes adaptively, in accordance with one example embodiment of the present disclosure.

FIG. 4 is a drawing representing an example process of the specific delayed node interacting with the existing service nodes in the second case, wherein the specific delayed node performs the method for restoring the blockchain network via the synchronizations while maintaining the reliability on the backup data and minimizing resource usage by converting the identities of the nodes adaptively, in accordance with one example embodiment of the present disclosure.

### DETAILED DESCRIPTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the present disclosure, although different, are not necessarily mutually exclusive. For example, a particular feature, structure, or characteristic described herein in connection with one embodiment may be implemented within other embodiments without departing from the spirit and scope of the present disclosure. In addition, it is to be understood that the position or arrangement of individual elements within each disclosed embodiment may be modified without departing from the spirit and scope of the present disclosure. The following detailed description is, therefore, not to be taken in a limiting sense, and the scope of the present disclosure is defined only by the appended claims, appropriately interpreted, along with the full range of equivalents to which the claims are entitled. In the drawings, like numerals refer to the same or similar functionality throughout the several views. It should be also noted that, in some implementations, triggering commands noted in the process may occur in a different order, may occur concurrently, and/or may be omitted.

To allow those skilled in the art to the present disclosure to be carried out easily, the example embodiments of the present disclosure by referring to attached diagrams will be explained in detail as shown below.

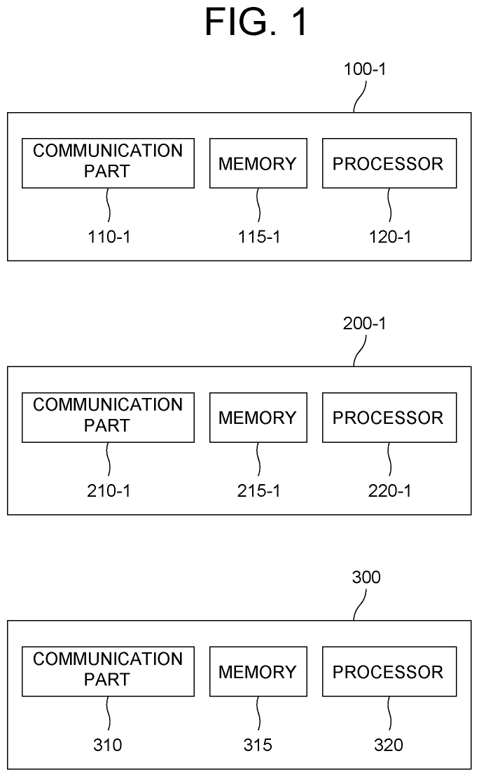

FIG. 1 is a drawing representing a specific delayed node among one or more delayed nodes in a blockchain network, a specific existing service node among one or more existing service nodes in the blockchain network, and an administrating device in the blockchain network, which perform a method for restoring a blockchain network via synchronizations while maintaining a reliability on backup data and minimizing resource usage by converting identities of nodes adaptively, in accordance with one example embodiment of the present disclosure.

By referring to FIG. 1, the specific delayed node 100-1, the specific existing service node 200-1, and the administrating device 300 may respectively include one or more communication parts 110-1, 210-1, 310, one or more processors 120-1, 220-1, 320, and one or more memories 115-1, 215-1, 315. Specifically, input and output processes, and operation processes of the specific delayed node 100-1, the specific existing service node 200-1 and the administrating device 300 may be performed respectively by the communication parts 110-1, 210-1, 310, and the processors 120-1, 220-1, 320. In FIG. 1, detailed explanations on connections among the communication parts 110-1, 210-1, 310 and the processors 120-1, 220-1, 320 are omitted. Herein, the memories 115-1, 215-1, 315 may have been stored with one or more instructions which will be described later, and the processors 120-1, 220-1, 320 may be set to perform the instructions stored in the memories 115-1, 215-1, 315, which will be described later. Also, it should be noted that, descriptions of the specific delayed node 100-1, the specific existing service node 200-1, and the administrating device do not exclude cases that one or more integrated processors are included in the specific delayed node 100-1, the specific existing service node 200-1, and the administrating device. Herein the integrated processor is a combined form of one or more media, one or more processors, and one or more memories.

Additionally, configurations of other delayed nodes 100-2 to 100-K and other existing service nodes 200-2 to 200-N, which will be described later in drawings and a description of the present disclosure, may also be identical or similar to those of the specific delayed node 100-1 and the specific existing service node 200-1, respectively.

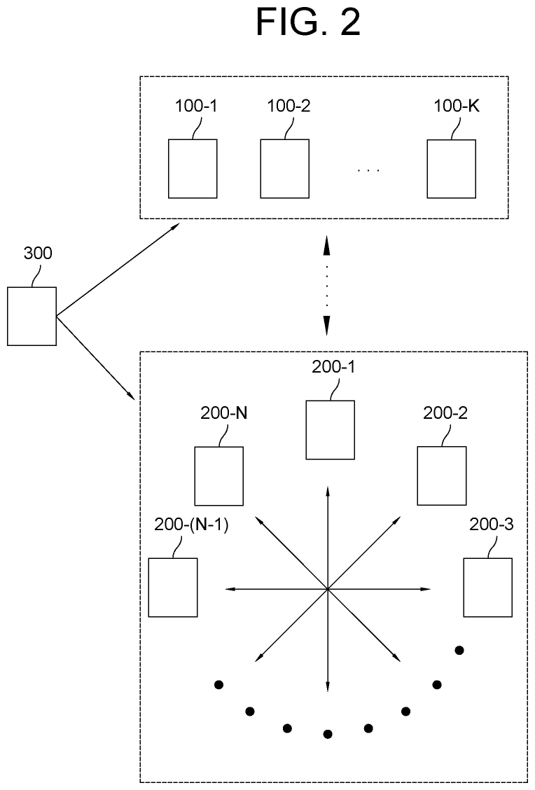

Meanwhile, respective functions of the delayed nodes 100-1 to 100-K, the existing service nodes 200-1 to 200-N, and the administrating device 300 and relationships thereamong are explained below by referring to FIG. 2.

FIG. 2 is a drawing representing the relationships among the delayed nodes, the existing service nodes, and the administrating device, which perform the method for restoring the blockchain network via the synchronizations while maintaining the reliability on the backup data and minimizing resource usage by converting the identities of the nodes adaptively, in accordance with one example embodiment of the present disclosure.

By referring to FIG. 2, the existing service nodes 200-1 to 200-N may be set to perform their corresponding functions in response to one of a first to a third triggering commands from the administrating device 300. Usually, each of the existing service nodes 200-1 to 200-N, connected with one another as shown in FIG. 2, continuously performs general synchronization. Herein, the general synchronization represents synchronization among the existing service nodes 200-1 to 200-N in order to form a distributed data storage environment by generating and storing the same blocks respectively in each of the existing service nodes 200-1 to 200-N. While the general synchronization is performed among the existing service nodes 200-1 to 200-N, in response to one of the triggering commands from the administrating device 300, the existing service nodes 200-1 to 200-N may perform specific functions. The triggering commands may be automatically generated by a programed algorithm or manually entered by an administrator into the administrating device 300.

Meanwhile, each of the delayed nodes 100-1 to 100-K may also be set to perform its corresponding function in response to a conversion triggering command from the administrating device 300. The difference from the existing service nodes 200-1 to 200-N is that each of the delayed nodes 100-1 to 100-K performs delayed synchronization. Herein, the delayed synchronization represents synchronization performed by each of the delayed nodes 100-1 to 100-K lagging behind the existing service nodes 200-1 to 200-N while maintaining its corresponding delay according to its corresponding initial setting. By maintaining the delays, the delayed nodes 100-1 to 100-K may acquire delayed blocks via the delayed synchronization and use the delayed blocks on a process of restoring the existing service nodes 200-1 to 200-N, of which process will be described later.

The delayed nodes 100-1 to 100-K may have different delays from one another for the sake of convenience of the administrator. For example, a delayed node may have a delay corresponding to a day, another delayed node may have a delay corresponding to 7 days, and still another delayed node may have a delay corresponding to 30 days. Or, in order to back up data for each day of the week, 7 delayed nodes may respectively have their corresponding delays, e.g., delays corresponding to 1 to 7 days. On the other hand, each of the delayed nodes 100-1 to 100-K may have identical delays with one another. By having the identical delays, multiple delayed nodes may multiplex backup data. Aforementioned embodiments can be modified according to a circumstance of a service using the blockchain network.

Meanwhile, the process of restoring the existing service nodes is explained below. For the sake of convenience, in the blockchain network, each of the existing service nodes 200-1 to 200-N and each of the delayed nodes 100-1 to 100-K are assumed as generating a block per second. It is also assumed that there are three delayed nodes 100-1, 100-2, 100-3, which have respective delays of 864000 blocks, 604800 blocks, and 2592000 blocks, each of which is a corresponding amount of blocks generated during a day, 7 days, and 30 days. It should be noted that, even though the process is explained based on the specific delayed node 100-1 and the specific existing service node 200-1 for the sake of convenience, each of other delayed nodes and each of other existing service nodes may perform the process identically when an identical triggering command is acquired.

First, as aforementioned, the specific existing service node 200-1 continuously performs the general synchronization with other existing service nodes 200-2 to 200-N, and the specific delayed node 100-1 performs the delayed synchronization while maintaining a delay of 86400 blocks, i.e., lagging behind the specific existing service node 200-1 by 86400 blocks, which is a corresponding amount of blocks generated during a day.

Herein, the administrating device 300 may transmit the first triggering command to the existing service nodes 200-1 to 200-N. To be specific, the administrating device 300 may transmit the first triggering command when the administrator detects an error in a certain block or when a necessity for rolling back the blockchain network to a particular point of time is arisen. When the first triggering command is acquired, the specific existing service node 200-1 may stop the general synchronization with other existing service nodes 200-2 to 200-N and initialize itself.

Thereafter, the administrating device 300 may transmit the conversion triggering command to the specific delayed node 100-1. To be specific, the administrating device 300 may choose a delayed node, e.g., the specific delayed node 100-1, among the delayed nodes 100-1 to 100-K and transmit the conversion triggering command to the specific delayed node 100-1. Herein, the choice can be made manually by the administrator or automatically by the administrating device 300. For example, by entering information on the specific delayed node 100-1 into the administrating device 300, the administrator may allow the administrating device 300 to transmit the conversion triggering command to the specific delayed node 100-1, or, by entering a certain block number of the certain block where the error occurs, the administrator may allow the administrating device 300 to refer to the certain block number to thereby choose an appropriate delayed node, e.g., the specific delayed node 100-1, and transmit the conversion triggering command to the specific delayed node 100-1. In the latter case, the administrating device 300 refers to the certain block number in order to point out a certain point of time when the certain block is generated, chooses the specific delayed node 100-1 which has generated a latest delayed block most recently and yet before the certain point of time, and sends the conversion triggering command to the specific delayed node 100-1.

When the conversion triggering command is acquired from the administrating device 300, by referring to the conversion triggering command, the specific delayed node 100-1 may allow at least some of the existing service nodes 200-1 to 200-N to perform restoration synchronization, wherein the restoration synchronization is performed based on blocks included in the specific delayed node 100-1 without maintaining any delay. Herein, by performing the restoration synchronization, at least some of the existing service nodes 200-1 to 200-N may maintain identities thereof, which will be described later. Meanwhile, when it comes to operating mechanism of the specific delayed node 100-1, a process of converting the identity of the specific delayed node 100-1 has two example embodiments as follows. In a first example embodiment, the specific delayed node 100-1 may refer to the second triggering command and automatically distinguish a first case from a second case to thereby decide necessary process.

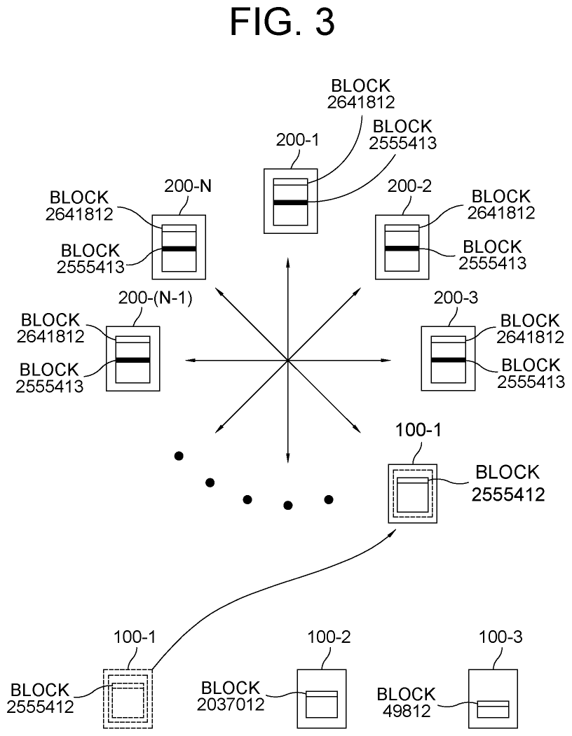

In the first case, a reference block number is identical to a latest delayed block number of the specific delayed block 100-1. Herein, the reference block is a latest block in each of the existing service nodes before the error occurs. Further, the reference block number is a block number, which is included in the conversion triggering command, corresponding to the reference block. By referring to FIG. 3, since the specific delayed node 100-1 already has exact blocks to restore the existing service nodes 200-1 to 200-N, the specific delayed node 100-1 may immediately allow at least some of the existing service nodes 200-1 to 200-N to perform the restoration synchronization.

FIG. 3 is a drawing representing an example process of the specific delayed node interacting with the existing service nodes in the first case, wherein the specific delayed node performs the method for restoring the blockchain network via the synchronizations while maintaining the reliability on the backup data and minimizing resource usage by converting the identities of the nodes adaptively, in accordance with one example embodiment of the present disclosure.

In FIG. 3, the error occurs in block 2555413, and the latest service block in each of the existing service nodes is a block 2641812. Herein, since the latest service block in each of the existing service nodes before the error occurs is a block 2555412, the administrating device 300 may transmit the conversion triggering command including the block number 2555412 to the specific delayed node 100-1. Since the reference block number is identical to the latest delayed block number, the specific delayed node 100-1 may immediately allow at least some of the existing service nodes 200-1 to 200-N to perform the restoration synchronization.

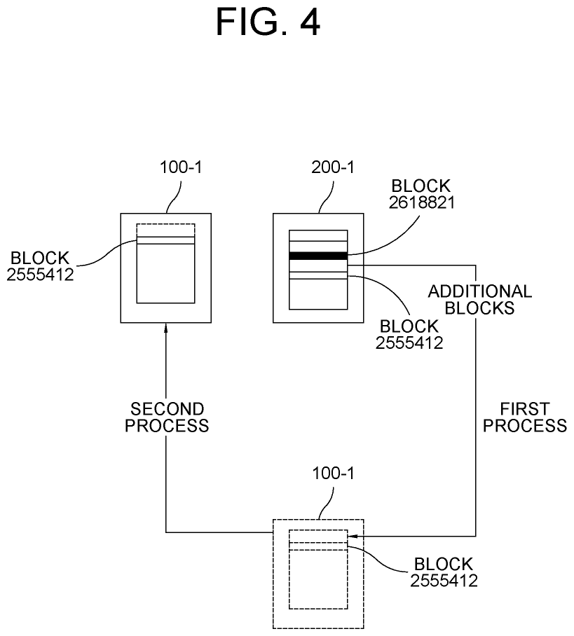

Meanwhile, in the second case, the reference block number is bigger than the latest delayed block number. Further, by referring to FIG. 4, since the specific delayed node 100-1 needs more blocks to restore the existing service nodes 200-1 to 200-N, the specific delayed node 100-1 may perform so-called additional synchronization and allow at least some of the existing service nodes 200-1 to 200-N to perform the restoration synchronization. Herein, the additional synchronization represents synchronization with the existing service nodes 200-1 to 200-N in order to update the specific delayed node 100-1. During the additional synchronization process, the specific delayed node 100-1 may obtain additional blocks comprised of from a subsequent block of the latest delayed block to the reference block.

FIG. 4 is a drawing representing an example process of the specific delayed node interacting with the existing service nodes in the second case, wherein the specific delayed node performs the method for restoring the blockchain network via the synchronizations while maintaining the reliability on the backup data and minimizing resource usage by converting the identities of the nodes adaptively, in accordance with one example embodiment of the present disclosure.

In FIG. 4, the error occurs in a block 2618821, and the latest service block in each of the existing service nodes is a block 2641812. Herein, since the latest service block in each of the existing service nodes before the error occurs is a block 2618820, the administrating device 300 may transmit the conversion triggering command including the block number 2618820 to the specific delayed node 100-1. Since the reference block number is bigger than the latest delayed block number, the specific delayed node 100-1 may perform the additional synchronization to thereby obtain additional blocks comprised of from a block 2555413 to the block 2618820 and may allow at least some of the existing service nodes 200-1 to 200-N to perform the restoration synchronization based on the block 1 to the block 2618820.

When it comes to operating mechanism of the existing service nodes 200-1 to 200-N, after initializing itself in response to the first triggering command as aforementioned, the specific existing service node 200-1 may perform a corresponding function in response to either the second triggering command or the third triggering command.

In case the specific existing service node 200-1 acquires the second triggering command, an identity of the specific existing service node 200-1 is maintained as it is. In other words, the specific existing service node 200-1 may perform the restoration synchronization with the specific delayed node 100-1, to thereby complete an updated service data chain, resulting in restoring the specific existing service node 200-1. Herein, the updated service data chain may be comprised of the existing service nodes 200-1 to 200-N and the specific delayed node 100-1. After the restoration synchronization swiftly completes the updated service data chain, the identities of specific delayed node 100-1 may be considered as a new service node, since the blockchain network operates based on the updated service data chain.

In case the specific existing service node 200-1 acquires the third triggering command, the identity of existing service node 200-1 is converted into a new delayed node. In other words, by referring to information on a certain delay included in the third triggering command, the specific service node 200-1 may perform the delayed synchronization with the updated service data chain while maintaining the certain delay. It is also possible for the existing specific delayed node 100-1 to have the certain delay identical to the specific delay of the specific delay 100-1 as the new delayed node.

Meanwhile, in a second example embodiment, the administrator may manually enter instructions for the necessary process.

Herein, the administrator may enter the instructions for the specific delayed node 100-1 directly into the administrating device 300. A format of the conversion triggering command in the second example embodiment may differ from that of the conversion triggering command in the first example embodiment. To be specific, the conversion triggering command in the second example embodiment may include an instruction for conversion without an instruction for the additional synchronization, or may include both the instruction for the conversion and the instruction for the additional synchronization. Herein, the instruction for the additional synchronization may include the aforementioned reference block number.

First, in case the conversion triggering command includes the instruction for the conversion without the additional synchronization, the specific delayed node 100-1 stops the delayed synchronization, and allows at least some of the existing service nodes 200-1 to 200-N to perform the restoration synchronization. And, in case the conversion triggering command includes both the instruction for the conversion and the instruction for the additional synchronization, the specific delayed node 100-1 stops the delayed synchronization, performs the additional synchronization by referring to the reference block number, and allows at least some of the existing service nodes 200-1 to 200-N to perform the restoration synchronization. A detailed explanation is omitted as it can be easily understood by referring to the first example embodiment.

Restoring the blockchain network with the aforementioned method has an advantage in a processing speed since a process of obtaining the backup data has already been written on the blockchain network, and an advantage in a minimizing resource usage since the identity of the specific delayed node 100-1 is adaptively converted.

The present disclosure has an effect of providing the method for restoring the blockchain network via the synchronizations while maintaining the reliability on the backup data.

The present disclosure has another effect of providing a prompt and easy method for restoring the blockchain network via the synchronizations while maintaining the reliability on the backup data to an administrator.

The present disclosure has still another effect of providing the method for restoring the blockchain network via the synchronizations while minimizing resource usage by converting the identities of the nodes adaptively.

The embodiments of the present invention as explained above can be implemented in a form of executable program command through a variety of computer means recordable to computer readable media. The computer readable media may include solely or in combination, program commands, data files, and data structures. The program commands recorded to the media may be components specially designed for the present invention or may be usable to a skilled human in a field of computer software. Computer readable media include magnetic media such as hard disk, floppy disk, and magnetic tape, optical media such as CD-ROM and DVD, magneto-optical media such as floptical disk and hardware devices such as ROM, RAM, and flash memory specially designed to store and carry out program commands. Program commands include not only a machine language code made by a compiler but also a high level code that can be used by an interpreter etc., which is executed by a computer. The aforementioned hardware device can work as more than a software module to perform the action of the present invention and they can do the same in the opposite case.

As seen above, the present invention has been explained by specific matters such as detailed components, limited embodiments, and drawings. They have been provided only to help more general understanding of the present invention. It, however, will be understood by those skilled in the art that various changes and modification may be made from the description without departing from the spirit and scope of the invention as defined in the following claims.

Accordingly, the thought of the present invention must not be confined to the explained embodiments, and the following patent claims as well as everything including variations equal or equivalent to the patent claims pertain to the category of the thought of the present invention.

What is claimed is:

1. A method for restoring a blockchain network via synchronizations while maintaining a reliability on backup data and minimizing resource usage by converting identities of nodes adaptively, comprising steps of:
(a) a specific delayed node among one or more delayed nodes in the blockchain network performing delayed synchronization, wherein the delayed synchronization represents synchronization with the existing service nodes while the specific delayed node maintains a specific delay according to a specific initial setting of the specific delayed node; and
(b) the specific delayed node which is set to perform a conversion of an identity thereof when a triggering command is acquired from an administrating device in the blockchain network, in response to acquiring the triggering command, allowing at least some of the existing service nodes to perform restoration synchronization, to thereby convert the identity thereof into a new service node, wherein the restoration synchronization represents synchronization based on blocks included in the specific delayed node without the specific delay.

2. The method of claim 1, wherein, at the step of (b), the specific delayed node, by referring to a reference block number in the triggering command and a latest delayed block number of the specific delayed node, wherein the reference block number represents a latest service block number in each of the existing service nodes before an error occurs, performs (i) a process of stopping the delayed synchronization and allowing at least some of the existing service nodes to perform the restoration synchronization in a first case, wherein the first case represents a case in which the reference block number corresponds to the latest delayed block number, and (ii) a process of stopping the delayed synchronization, performing additional synchronization, and allowing at least some of the existing service nodes to perform the restoration synchronization in a second case, wherein the second case represents a case in which the reference block number is bigger than the latest delayed block number, and wherein the additional synchronization represents synchronization with the existing service nodes to thereby update the specific delayed node.

3. The method of claim 2, wherein, at the step of (b), in the second case, during the process of performing the additional synchronization, the specific delayed node is updated by acquiring additional blocks comprised of from a subsequent block of the latest delayed block thereof to the reference block.

4. The method of claim 1, wherein, at the step of (b), the specific delayed node performs (i) a process of stopping the delayed synchronization and allowing at least some of the existing service nodes to perform the restoration synchronization in a first case, wherein the first case represents a case in which the triggering command includes an instruction for converting the identity thereof without additional synchronization, and (ii) a process of stopping the delayed synchronization, performing the additional synchronization by referring to a reference block number in the triggering command, and allowing at least some of the existing service nodes to perform the restoration synchronization in a second case, wherein the second case represents a case in which the triggering command includes both the instruction for the converting the identity thereof and an instruction for the additional synchronization, wherein the reference block number represents a latest service block number in the existing service nodes before an error occurs, and wherein the additional synchronization represents synchronization with the existing service nodes by obtaining additional blocks comprised of from a subsequent block of a latest delayed block thereof to the reference block.

5. The method of claim 1, wherein the blockchain network includes each of the delayed nodes set by the administrating device to have each of delays, and
wherein the administrating device transmits the triggering command to the specific delayed node, to thereby allow the identity of the specific delayed node to be converted into the new service node, while the rest of the delayed nodes, which are failed to acquire the triggering command, maintain their identity as the delayed nodes.

6. A method for restoring a blockchain network via synchronizations while maintaining a reliability on backup data and minimizing resource usage by converting identities of nodes adaptively, comprising steps of:
(a) a specific existing service node among one or more existing service nodes in the blockchain network, which is set to perform a corresponding function when one of a first to a third triggering commands is acquired from an administrating device in the blockchain network, performing a process of initializing itself when the first triggering command is acquired; and
(b) the specific existing service node performing a process of (i) if the second triggering command is acquired, performing restoration synchronization with a specific delayed node among one or more delayed nodes in the blockchain network, to thereby allow an identity of the specific delayed node to be converted into a new service node in response to a conversion triggering command, resulting in completeness of an updated service data chain comprised of the existing service nodes and the new service node, wherein the restoration synchronization represents synchronization based on blocks included in the specific delayed node without the specific delay, and (ii) if the third triggering command is acquired, by referring to information on a certain delay included in the third triggering command, performing delayed synchronization with the updated service data chain while maintaining the certain delay, to thereby convert an identity thereof into a new delayed node.

7. The method of claim 6, wherein, before the step of (a), the specific delayed node performs delayed synchronization with the existing service nodes, and
wherein, at the step of (b), in case that the specific existing service node acquires the second triggering command, the specific delayed node allows the specific existing service node to perform the restoration synchronization, to thereby maintain the identity of the specific existing service node as it is.

8. A specific delayed node among one or more delayed nodes in a blockchain network for restoring the blockchain network via synchronizations while maintaining a reliability on backup data and minimizing resource usage, comprising:
at least one memory that stores instructions; and
at least one processor configured to execute the instructions to perform or support another device to perform: (I) a process of performing delayed synchronization, wherein the delayed synchronization represents synchronization with the existing service nodes while the specific delayed node maintains a specific delay according to a specific initial setting of the specific delayed node, and (II) in response to acquiring the triggering command from an administrating device in the blockchain network, a process of allowing at least some of the existing service nodes to perform restoration synchronization, to thereby convert the identity thereof into a new service node, wherein the restoration synchronization represents synchronization based on blocks included in the specific delayed node without the specific delay.

9. The specific delayed node of claim 8, wherein, at the process of (II), the processor, by referring to a reference block number in the triggering command and a latest delayed block number of the specific delayed node, wherein the reference block number represents a latest service block number in each of the existing service nodes before an error occurs, performs (i) a process of stopping the delayed synchronization and allowing at least some of the existing service nodes to perform the restoration synchronization in a first case, wherein the first case represents a case in which the reference block number corresponds to the latest delayed block number, and (ii) a process of stopping the delayed synchronization, performing additional synchronization, and allowing at least some of the existing service nodes to perform the restoration synchronization in a second case, wherein the second case represents a case in which the reference block number is bigger than the latest delayed block number, and wherein the additional synchronization represents synchronization with the existing service nodes to thereby update the specific delayed node.

10. The specific delayed node of claim 9, wherein, at the process of (II), in the second case, during the process of performing the additional synchronization, the specific delayed node is updated by acquiring additional blocks comprised of from a subsequent block of the latest delayed block thereof to the reference block.

11. The specific delayed node of claim 8, wherein, at the process of (II), the processor performs (i) a process of stopping the delayed synchronization and allowing at least some of the existing service nodes to perform the restoration synchronization in a first case, wherein the first case represents a case in which the triggering command includes an instruction for converting the identity thereof without additional synchronization, and (ii) a process of stopping the delayed synchronization, performing the additional synchronization by referring to a reference block number in the triggering command, and allowing at least some of the existing service nodes to perform the restoration synchronization in a second case, wherein the second case represents a case in which the triggering command includes both the instruction for the converting the identity thereof and an instruction for the additional synchronization, wherein the reference block number represents a latest service block number in the existing service nodes before an error occurs, and wherein the additional synchronization represents synchronization with the existing service nodes by obtaining additional blocks comprised of from a subsequent block of a latest delayed block thereof to the reference block.

12. The specific delayed node of claim 8, wherein the blockchain network includes each of the delayed nodes set by the administrating device to have each of delays, and wherein the administrating device transmits the triggering command to the specific delayed node, to thereby allow the identity of the specific delayed node to be converted into the new service node, while the rest of the delayed nodes, which are failed to acquire the triggering command, maintain their identity as the delayed nodes.

13. A specific existing service node among one or more existing service nodes in a blockchain network for restoring the blockchain network via synchronizations while maintaining a reliability on backup data and minimizing resource usage, comprising:
at least one memory that stores instructions; and
at least one processor configured to execute the instructions to perform or support another device to perform: (I) a process of performing a process of initializing itself when a first triggering command is acquired, (II) a process of performing a process of (i) if a second triggering command is acquired, performing restoration synchronization with a specific delayed node among one or more delayed nodes in the blockchain network, to thereby allow an identity of the specific delayed node to be converted into a new service node in response to a conversion triggering command, resulting in completeness of an updated service data chain comprised of the existing service nodes and the new service node, wherein the restoration synchronization represents synchronization based on blocks included in the specific delayed node without the specific delay, and (ii) if a third triggering command is acquired, by referring to information on a certain delay included in the third triggering command, performing delayed synchronization with the updated service data chain while maintaining the certain delay, to thereby convert an identity thereof into a new delayed node.

14. The specific existing service node of claim 13, wherein, before the process of (II), the specific delayed node performs delayed synchronization with the existing service nodes, and wherein, at the process of (II), in case that the processor acquires the second triggering command, the specific delayed node allows the specific existing service node to perform the restoration synchronization, to thereby maintain the identity of the specific existing service node as it is.
